(19) United States
(12) Patent Application Publication
(10) Pub. No.: US 2006/0087523 A1
(43) Pub. Date: Apr. 27, 2006

(54) Printing device and method using valve control

(76) Inventors: David Andrew Horsnell, Cambridge (GB); Matthew Brian Tomlin, Cambridge (GB); Ammar Lecheheb, Cambridge (GB); Oliver John Prime, Cambridge (GB); Michael James Fox, Rutland (GB); Christopher Michael Bates, Kettering (GB)

Correspondence Address: MCANDREWS HELD & MALLOY, LTD, 500 WEST MADISON STREET, SUITE 3400, CHICAGO, IL, 60661, US

(21) Appl. No.: 10/521,686

(22) PCT Filed: Jul. 11, 2003
(86) PCT No.: PCT/GB03/03026

§ 371 Date: Sep. 19, 2005

(30) Foreign Application Priority Data
Jul. 25, 2002 (GB) 0217248.4

(51) Int. Cl. B41J 29/38

(52) U.S. Cl. 347/5

(57) ABSTRACT

The present invention provides a method of printing an image, and an apparatus for performing the method, the method comprising the steps of: (a) generating print data representing the image to be printed; (b) dividing the print data into a plurality of sub-elements; (c) writing each print data sub-element into respective memory means locations; (d) sequentially reading the memory means; and (e) printing an iamb by activating a print valve in accordance with print data sub-element read from the memory means. The method enables printing heads to be slanted such that different print heights can be obtained whilst still printing in a vertical orientation.

The present invention relates to a device that can be used to control the operation of a print head and to a method for controlling a print head under operation.

Ink jet printers are non-contact printers in which dots of ink are ejected from one or more nozzle orifices so as progressively to build up a printed image on a substrate moved-relative to the nozzle. One form of ink jet printer comprises a source of ink under pressure, typically a reservoir or bottle of ink which is pressurised to from 0.1 to 2 bar, notably about 1 bar. The pressure is created, for example, by pressurising the air space above the ink in the bottle or reservoir from which ink is fed to the nozzle orifice(s) in a print head through which it is ejected as a series of droplets onto the surface of the substrate. The flow of ink through the each nozzle orifice is controlled by a solenoid valve. Typically, such a valve comprises an electromagnetic plunger journalled for axial movement within an axially extending electric coil. The distal end of the plunger is located within a valve head chamber through which ink flows from the reservoir to the nozzle orifice. When current is fed through the coil, this generates a magnetic field which acts on the plunger to move it axially and thus open, or shut, the inlet to nozzle orifice. Typically, the magnetic field acts to retract the plunger against the bias of a coil spring to create a flow path between the valve head chamber and the nozzle orifice. When the electric current no longer flows in the coil, the magnetic field ceases and the plunger returns under the bias of the spring to seat against sealing ribs, lips or other means located at or around the inlet to a bore leading to the nozzle orifice to close the flow path to the nozzle orifice. For convenience, the term drop on demand printer will be used to denote in general such types of ink jet printer.

Conventional ink jet print heads have employed electro-mechanical control and actuation systems that open the valve for a pre-determined period of time so that an ink drop can be ejected. The time for which the valve is held open determines the quantity of ink that is ejected from the valve and hence the size of the drop that will be formed on the substrate that is being printed upon. Adjustment of the valve open time is time consuming and laborious as typically a manual adjustment must be made to each valve within the print head matrix.

According to a first aspect of the present invention there is provided a head comprising a print valve and a print valve control means, the print valve control means comprising a first data input line to receive print data; memory means to store the received print data; processing means to process the stored print data, wherein the processing means, in use, (a) divides the print data into a plurality of sub-elements; (b) writes each print data sub-element to respective memory means locations within the memory means; (c) sequentially reads each print data sub-element from the memory means; and (d) activates the print valve in accordance with the print data sub-elements.

Preferably, the respective memory means locations are configured such that, in use, each memory sub-element is read from the memory means a substantially constant time period after the preceding memory sub-element. The print head can be rotated to a first orientation and the processor may change the value of the time period. Preferably the processor changes the value of the time period so that a printed image is printed at a second orientation. The memory means locations may be over-written by the processor following the sequential print data read.

According to a second aspect of the present invention there is provided a method of printing an image with a print head, the method comprising the steps of: (a) rotating the print head to a desired angle from the vertical; (b) generating a raster signal representing the image to be printed; (c) dividing the raster signal into a plurality of sub-elements; (d) writing each raster signal sub-element into respective memory means locations within a memory means; (e) sequentially reading each raster signal sub-element from the memory means; and (f) printing each raster signal sub-element from a print head, the printed image having a substantially vertical orientation.

According to a third aspect of the present invention there is provided a method of printing an image, the method comprising the steps of: (a) generating print data representing the image to be printed; (b) dividing the print data into a plurality of sub-elements; (c) writing each print data sub-element into respective memory means locations; (d) sequentially reading the memory means; and (e) printing an image by activating a print valve in accordance with print data sub-element read from the memory means.

A preferred embodiment of the invention and its operation under on-line software control will now be described by way of illustration only and with respect to the accompanying drawings, in which

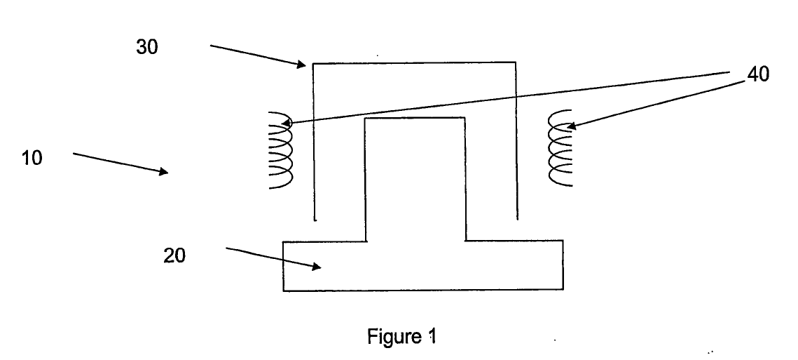

FIG. 1 shows a schematic depiction of a solenoid valve which is suitable for use with the method of the present invention;

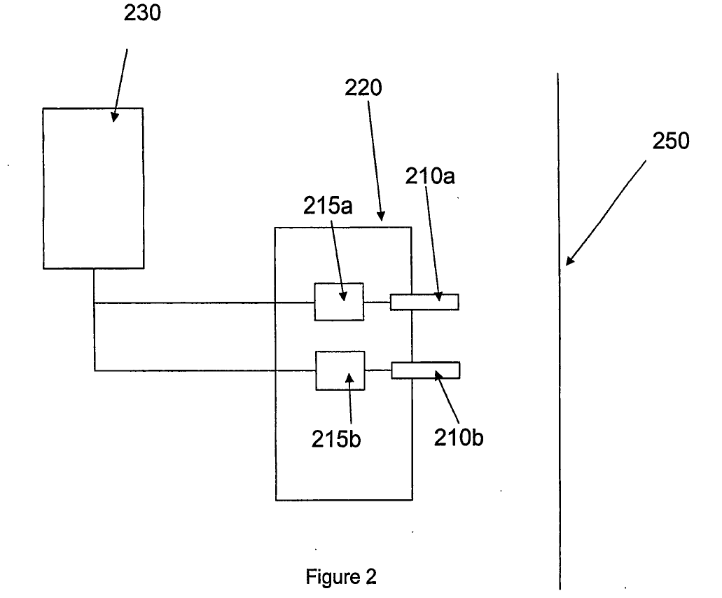

FIG. 2 shows a schematic depiction of a printer apparatus that is operated according to the present invention;

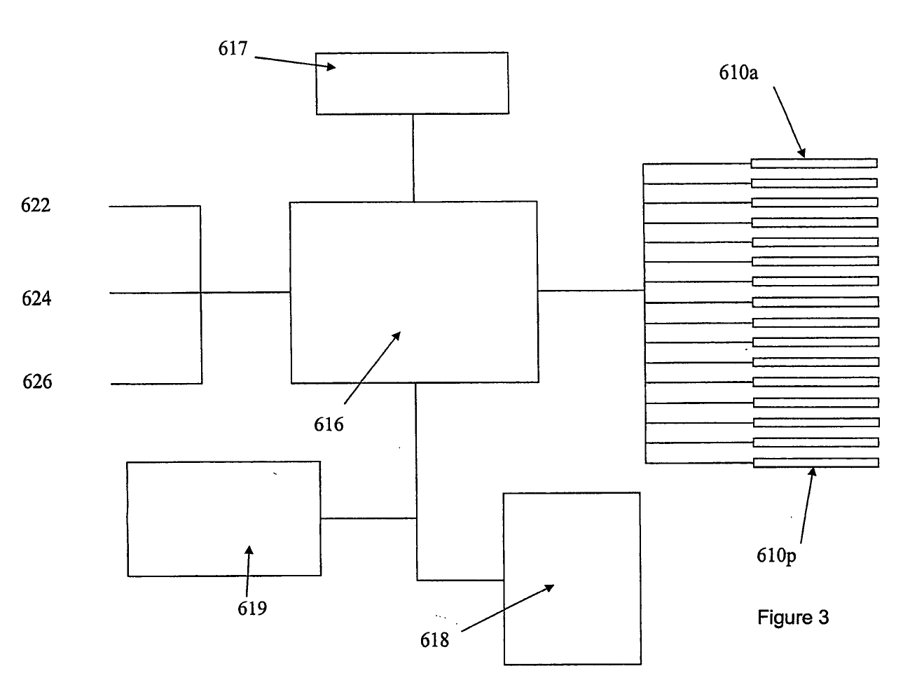

FIG. 3 shows a first schematic depiction of a preferred embodiment of printer apparatus that is operated according to the present invention;

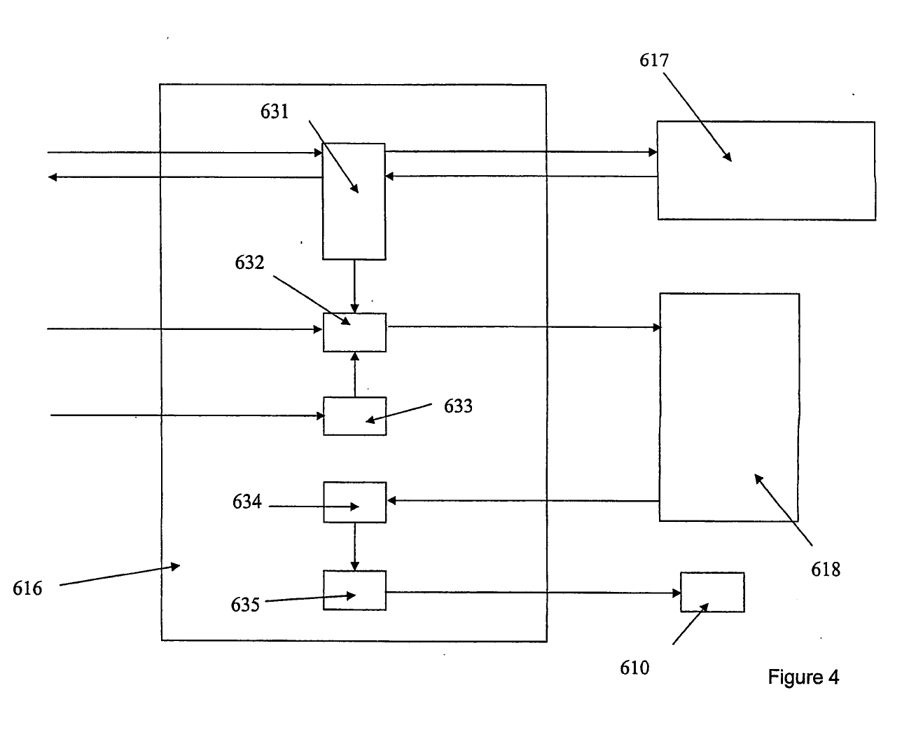

FIG. 4 shows a second schematic depiction of a preferred embodiment of printer apparatus that is operated according to the present invention;

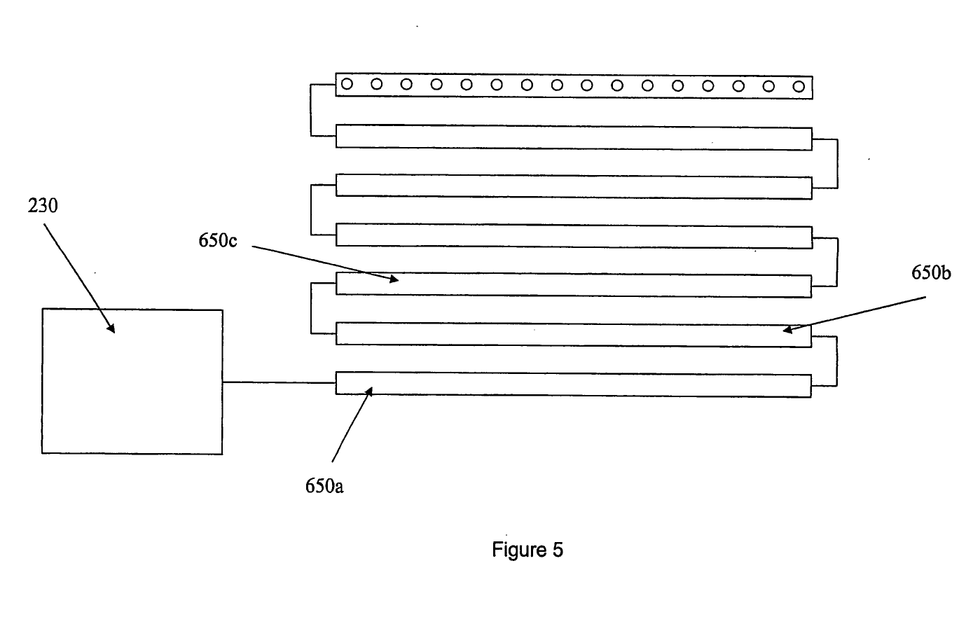

FIG. 5 shows a third schematic depiction of a preferred embodiment of printer apparatus that is operated according to the present invention; and

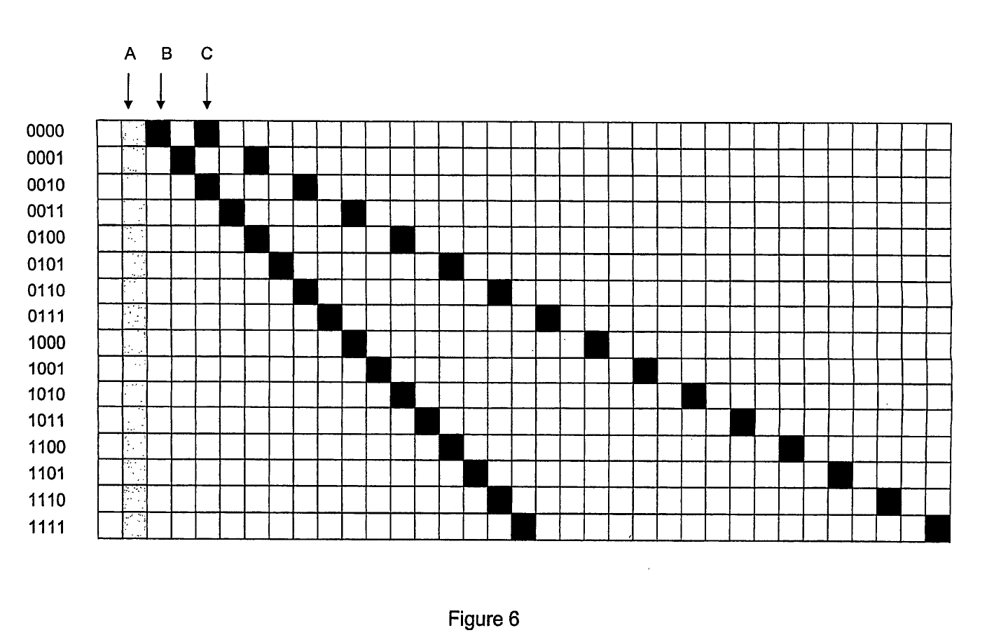

FIG. 6 shows a schematic depiction of a method according to the present invention.

FIG. 1 shows a schematic depiction of a solenoid valve 10 which is suitable for use with the method of the present invention. The valve 10 comprises plunger 20, tube 30 and coils 40. The plunger 20 comprises a ferromagnetic material (or any other magnetic material) and is received within the tube 30 so as to be able to move freely along the axis of the tube. The plunger can be impelled, for example towards the open end of the tube, by the application of a current to the coils 40, the current generating a magnetic field within the tube, which causes a magneto motive force to act upon the plunger. The timing and frequency of the current pulses applied to the coils can be controlled by computer (not shown). The solenoid valve additionally comprises a return mechanism (not shown), such as a spring, that acts to return the plunger to its initial position once the plunger has completed its full range of travel.

In practice, a print head will comprise a matrix of such valves that are arranged in a linear, square or rectangular arrangement. FIG. 2 shows two exemplary valves 210a, 210b from such a print head matrix 220. Associated with each valve is valve control means 215a, 215b, each of the valve control means being in communication with a central computer system 230. The operation of each valve is controlled by the transmission of control pulses from the central computer system 230 to each of the valve control means 215a, 215b. Rather than transmitting a single pulse to ‘fire’ the valves for a pre-determined period of time, the central computer system can transmit more complex signals that are interpreted within the respective valve control systems in order to control the behaviour of the valve. For example, the signal may be byte wide and if the value is within a certain range, for example from 25-255 then this may indicate that the valve be held open for a time that is proportional to the value of the signal, for example for 25-255 μs. Certain values of the signal may cause the valve to be held open for a pre-determined period of time, with that time period being calculated or retrieved from memory by the valve control means in accordance with the value of the signal. Certain signal values may also be used to initiate other actions from the valve, for example reporting back a parameter associated with the valve, such as the volume of ink consumed, or as a prompt to the valve control means that new or updated control data is to be transmitted to the valve control means that is to be stored in memory within the valve control means. If greater than 256 values are required to provide all of the control signals then the size of the control signal may be increased. If it is desired to transmit individual signals to each valve then the signals may be transmitted using some form of time or frequency division multiplexing. Alternatively additional bits may be added to the control signals so that valves may be addressed individually, or as blocks forming a sub-set of the printer head matrix. Similarly, the time for which each valve is to be held open may be altered by a constant time period, for example 1 or 10 μs, in order to produce spot sizes of a slightly different sizes.

In a preferred embodiment, the valve control means comprise a field programmable gate array (FPGA). FPGAs comprise memory and logic elements that can be configured by the user to provide a desired functionality. In the preferred embodiment, the FPGA, and associated devices, is used to control a linear array of 16 valves. Referring to FIG. 3, the valves 610a, 610b, . . . , 610p are controlled by valve control means that comprise FPGA 616, electrically erasable programmable ROM (EEPROM) 617, RAM 618, programmable ROM (PROM) 619 and input/outputs 622, 624, 626. The FPGA 616 is connected to each of the valves 610a, 610b, . . . , 610p, EEPROM 617, RAM 618 & PROM 619. All three input/outputs 622, 624, 626 interface with the FPGA. When the FPGA is powered up, it loads its internal configuration data from PROM 619 and then follows the sequences that have been loaded from the PROM. The EEPROM 617 stores a range of data comprising a look-up table comprising data associated with each of the valves, data specific to the valve control means and FPGA, status information, etc. The FPGA will load this data from the EEPROM and then initialise the RAM 618, by writing zero values into each memory location in RAM. The FPGA will then wait to receive print data or other commands from one of the inputs. Input/output 622 is connected to the computer control system and input/output 624 can be used to connect to a further valve control means (see below with reference to FIG. 5). Input 626 provides a series of pulses that are used in co-ordinating the printing process. When the array of valves is printing onto a substrate, the substrate is normally moved underneath the valves. The series of pulses supplied to input 626 may be generated from an encoder applied to a shaft in the apparatus that is moving the substrate relative to the valves.

FIG. 4 shows a schematic depiction of a number of registers that are formed with the FPGA when the FPGA configuration data is loaded from PROM 619. The first register 631 is used to write to and read from the EEPROM 617 and is also used when initialisation data is read from the EEPROM. Second register 632 receives print data from the computer control system, such as the alphanumeric characters or bitmaps to be printed, or a signal to initiate a printing process. Second register 632 also writes print data to the RAM and is used to initialise the RAM during the start-up phase. The third register receives configuration data from the computer control system such as data controlling the slant that may be applied to the print head. Fourth register 634 receives print data from the RAM and passes it to the fifth register 635, which uses the print data to operate the valves 610.

A desired print image (which may include alphanumerical characters) is entered into the computer control system and this image is then converted into raster data that may be communicated with the valve control means. The valves 610 may be operated for different periods of time so as to provide the appearance of 16-level greyscale images. Thus the print data can be supplied in the form of a raster comprising a 4 bit word for each valve, with the value of the 4-bit word determining the greyscale that is to be generated by the valves. The print data is received by the second register and written into the RAM 618. The RAM is logically arranged in 16 rows, with each of the valves corresponding to a row. There are a plurality of columns, each of which corresponds to a time slot. Each raster scan also corresponds to a time slot and the time slot is determined by the frequency at which the shaft encoder supplies pulses to the FPGA.

When print data is received at the FPGA the second register interprets the greyscale data for each valve, obtaining the time that each valve must be opened for in order to generate the desired greyscale from a look-up table held in the first register. In theory, each valve should be held open for the same period of time in order to generate the dame greyscale, but mechanical variations in each valve will lead to each valve having slightly different characteristics. Calibration factors that account for these differences are held in the look-up table. The valve times are then written into the RAM, using as many columns as are necessary to store all of the rasters. A write pointer is set to the first column of the data. Each memory location holds the grey scale value for the associated valve and time slot.

When the next shaft encoder pulse is received the RAM column indicated by the write pointer is read to see which of the 16 valves need to be operated, i.e. which memory locations have non-zero entries. Once the memory locations have been read then all the memory locations in the column are overwritten with zero.

The identity of these valves, along with the time for which the valves are to be held open are then transmitted to the fourth register, which may perform further operations on the valve times in order to correct for valve operation at high speed or a long time period between subsequent operations of the valve. The valve times are then passed to the fifth register which calculates the number of shaft encoder pulses that are equivalent to the valve times. The valves are then opened for a period of time equal to that number of shaft encoder pulses.

As the valves 610 are electromechanical devices, their size provides a limitation to the print resolution that can be obtained. Typically, each valve may be provided at an offset of 4 mm from the adjacent valve(s). If a greater resolution (i.e. smaller pixel separation) is required then the matrix must be slanted so that the valves are closer together in one axis. For example, if the valves are in a linear array that is arranged so as to print vertically on a substrate with a 4 mm pixel separation, if it is desired to print with a vertical pixel separation of 2 mm then it will be necessary to rotate the valve array by 45°. The disadvantage of rotating the valve array is that if no correction is made to the raster signal then the printed images will not print in the correct orientation.

Such a correction may advantageously be provided using the RAM to provide a slant to the print raster data. Once the greyscale data has been translated into valve open times, rather than writing the valve data into a vertical column, as described above, the write data can be offset across a number of columns within the RAM, so as to reproduce the desired printing slant within RAM.

FIG. 6 shows a schematic depiction of the RAM 618 in which the RAM can be considered to be logically arranged into 16 rows and a plurality of columns (the number of columns used will depend upon the total amount of RAM used and this will be discussed below). Each row corresponds to one of the valves and the binary identity of each valve is shown next to each row in FIG. 6. When the valve array is unslanted and, for example, the desired print pattern is a straight line then, referring to the column indicated by A, when the signal indicating that a raster is to be printed (this is referred to as a ‘raster go’, or ‘RASGO’ signal) is received, the various valve open times will be written into the memory column indicated by the write pointer. When that column is indicated by the read pointer then the various valve open times will be written to the fourth register in order that the valves can be operated for the desired period of time. Then each memory location will be over-written with a zero value to indicate that the requested printing operation has been performed.

If the slant angle of the array is 45° then it will be necessary to offset the raster signal appropriately within RAM. When the RASGO is received, the valve open time for valve 0000 will be written into column indicated by B.

The valve open time for valve 0001 will be written into the next column and the valve open time for valve 0010 will be written into the column indicated by C. This offsetting is repeated such that the valve open time for valve 1111 is written into a column that is offset by 15 columns from column B. When column B is indicated by the read pointer then valve 0000 will be operated; when the next shaft encoder pulse is received the read pointer will indicate the next column and valve 0001 will be operated, and so on until all the valves have been operated. As each shaft encoder pulse indicates the movement of the substrate by a fixed increment, for example 10 μm, then the image produced by the sequential operation of the valves will offset the physical slant of the valves.

FIG. 6 additionally shows a further example of the slanting of the raster signal, in this case by 30°. The valve open time for valve 0000 will be written into column C, the valve open time for valve 0001 will be written into a column that is two columns offset from column C, and so on. The slating within RAM allows the valves to be angled to provide a desired pixel separation and to still print the desired image(s) in a vertical orientation. Although the above discussion was illustrated with the raster signal being a straight line, it will be understood that any alphanumeric character(s) or bit maps could be slanted using the method described above. It has been found that 48K of RAM is sufficient to enable the implementation of raster slanting (assuming a 16 valve array and 256 grey scale printing).

A desired pixel separation can be entered into the computer control system, and the computer control system can then cause the valve array to be rotated to the appropriate angle and communicate the necessary slant to the FPGA. Alternatively, the desired pixel separation may be communicated to the FPGA by the computer control system and the FPGA can control the valve rotation and the RAM slanting.

Typically the 16-level greyscale can be provided using valve open times between approximately 80 μs and 250 μs. It has been found advantageous to initially open the valve by providing a first voltage for a first period of time and to provide a second voltage, that is lower than the first voltage, for a further period of time in order to hold the valve open. This reduces the possibility that the valve remains open for longer than is required to provide the desired greyscale, leading to decreased printing performance. It has been found particularly advantageous to apply a 36V pulse for approximately 80 μs and a second pulse of approximately 5V for the remainder of the time that the valve remains open.

In a further preferred embodiment, the valve control means and valves described above with reference to FIG. 4 will be co-located upon a single circuit board 650. A number of circuit boards can then be connected in serial and physically located in a vertical array so that the valves can deposit a two-dimensional matrix on a print substrate. In such a case (see FIG. 5), one of the boards 650a will be connected via serial input/output 622 to the computer control system 230 and to the second board via serial input/output 624. The second board 650b will be connected to the first board via serial input/output 622 and to the third board 650c via serial input/output 624, and so on. The last board in the serial chain can detect its position as its serial input/output 624 will have no connection. On power up the last board in the serial chain assigns itself address 0 and transmits this address to the preceding board, which then assigns itself address 1. This process continues, with the address value being incremented until each board has an assigned address. The first board 650a will then report its address to the computer control system such that the system is aware of the number of connected boards. The system will prefix any communication with a board with the board's address. Preferably 16 boards are connected together to provide a 16×16 printing matrix.

The FPGA used in the preferred embodiment was a Xilinx Spartan II XC2S100 which was preferred as its configuration can be determined by the data loaded from the PROM during start up. Such an FPGA may be replaced by a cheaper device in which the FPGA is hardwired, for example by blowing fuses to form logic elements, rather than configurable through software.

It will be understood that the present invention is suitable for use with any type of solenoid valve and in any application in which solenoid valves are used. The applicant has found that the invention is of particular advantage when used with high speed solenoid valves that find advantage in drop on demand ink jet printers.

Specifically, the invention is of advantage when used with the high speed solenoid valve described in our copending application GB 0203439.5.

1. A print head comprising a rotatable print array comprising a plurality of print valves, a valve control means in communication with the print array a pulse generating means, in use generating a regular sequence of pulse signals and means for rotating, in use, the print array to a predetermined rotation;
the valve control means comprising:
one or more data input lines to receive print data;
memory means comprising an array of memory locations to store the received print data, one dimension of the array of memory locations being associated with the plurality of print valves of the rotatable print array and the other dimension of the array of memory locations being associated with a plurality of pre-determined time periods; and
processing means to process the stored print data, wherein the processing means, in use,
(a) processes the print data in accordance with the predetermined rotation of the rotatable print array;
(b) divides the print data into a plurality of sub-elements, each print data sub-element being associated with a respective print valve and a respective pre-determined time period;
(c) writes each print data sub-element to the memory location associated with the respective print valve and the respective pre-determined time period;
(d) sequentially reads one or More print data sub-elements from the memory locations associated with one pre-determined time period;
(e) activates the respective print valves associated with the one or more print data sub-elements read in step (d);
characterised in that step (d) is repeated for a subsequent pre-determined time period for each pulse generated by the pulse generating means.

2. A print head according to claim 1, wherein the processing means, in use;
(f) overwrites the memory locations read during step (d) after the activation of the print valves in step (e).

3. A method of printing an image with a print head comprising a rotatable print array comprising a plurality of print valves, the method comprising the steps of:
(a) rotating the print head to a predetermined rotation;
(b) generating a regular sequence of pulse signals;
(c) generating a raster signal representing the image to be printed;
(d) dividing the raster signal into a plurality of sub-elements;
(e) writing each raster signal sub-element into memory means comprising an array of memory locations to store the received print data, one dimension of the array of memory locations being associated with the plurality of print valves of the rotatable print array and the other dimension of the array of memory locations being associated with a plurality of pre-determined time periods;
(f) sequentially reading each raster signal sub-element from the memory locations associated with one pre-determined time period; and
(g) activating the respective print valves associated with each raster signal sub-element read in step (f);
characterized in that step (f) is repeated for a subsequent pre-determined time period for each pulse generated by the pulse generating means.

4. A method according to any of claims 8 to 12, wherein the method comprises the further step of
(q) over-writing the memory locations following the reading of the se raster signal sub-elements.
